(19) United States
(12) Patent Application Publication
(10) Pub. No.: US 2022/0367932 A1
(43) Pub. Date: Nov. 17, 2022

(54) BATTERY AND USE OF SUCH

(71) Applicant: Robert Bosch GmbH, Stuttgart (DE)

(72) Inventors: Markus Schmitt, Tamm (DE); Benjamin Kopp, Remseck Am Neckar (DE)

(21) Appl. No.: 17/741,236

(22) Filed: May 10, 2022

(30) Foreign Application Priority Data
May 11, 2021 (DE) 102021204787.4

(51) Int. Cl. H01M 10/63; H01M 10/613; H01M 10/625; H01M 10/6568; H01M 50/209

(52) U.S. Cl. CPC H01M 10/63; H01M 10/613; H01M 10/625; H01M 10/6568; H01M 50/209; H01M 2220/20

(57) ABSTRACT

A battery comprising a first housing element (2) and a second housing element (3), which jointly form an inner chamber (5) for receiving a battery module (6), wherein a plurality of battery cells (7) of the battery module (6) is arranged in the inner chamber (5), said battery cells being connected to one another, and wherein furthermore a first element (61) of a battery control system is arranged in the inner chamber (5), and the first housing element (2) forms a first temperature control structure (101) on a face that is remote from the inner chamber (5), and the second housing element (2) is furthermore connected to a third housing element (4) on a face that is remote from the inner chamber (5), wherein the third housing element (4) receives a second element (62) of the battery control system and forms a second temperature control structure (102).

### BACKGROUND OF THE INVENTION

The invention is based on a battery. Subject matter of the present invention is also the use of such.

It is known from the prior art that a battery module has a plurality of individual battery cells that each comprise a positive voltage tap-off and a negative voltage tap-off, wherein in order to connect the plurality of battery cells to one another in an electrically conductive manner in series and/or in parallel the respective voltage tap-offs are connected to one another in an electrically conductive manner and consequently connected together to form the battery module. Battery modules for their part are connected to batteries or to battery systems. On account of a multiplicity of possible different installation spaces in vehicles, variable module sizes are desired in order to be able to make optimal use of the available installation space.

Furthermore, the battery cells of a battery module, such as for example lithium ion battery cells or lithium polymer battery cells, heat up during operation on account of chemical conversion processes and on account of their electrical resistance as battery cells are discharged or charged. In particular, these processes have comparable characteristics in the case of a comparably quick discharge or charging procedure. The greater the capacity of a battery or a battery module, the more heat is produced and consequently the greater the requirements with regard to an efficient temperature control system. In order to increase the safety and reliability of a battery module and also to ensure the efficiency of the battery cells, the battery cells of a battery module need to warm up and cool down in order for them to be able to operate as far as possible in a determined temperature range, so that it is possible by way of example to prevent increased aging behavior or a degradation of the cell chemistry.

However, the battery cells primarily need to cool down.

By way of example, it is possible to control the temperature of the battery, in other words warm up or cool down the battery, by way of a fluid temperature control procedure using a water/glycol mixture. In this case, this mixture is directed through cooling plates that are arranged below the battery module. The cooling plate may be connected in this case to a corresponding component of a cooling circuit.

Prior art is, for example, EP 3 726 612.

### SUMMARY OF THE INVENTION

A battery according to the invention offers the advantage that it is possible to adapt the procedure of controlling the temperature of individual components of the battery to their respective requirements. In particular, it is possible by way of a configuration of two temperature control chambers to adapt and optimize the procedure to meet the requirements with regard to controlling the temperature of a plurality of battery cells and of components of the power electronics separately from one another.

For this purpose, a battery is provided in accordance with the invention.

The battery comprises a first housing element and a second housing element. The first housing element and the second housing element jointly form an inner chamber for receiving a battery module. In this case, a plurality of battery cells of the battery module is arranged in the inner chamber. The plurality of battery cells is connected in an electrically conductive manner in series and/or in parallel to one another. Furthermore, a first element of a battery control system is arranged in the inner chamber.

The first housing element forms a first temperature control structure on a face that is remote from the inner chamber. In particular, furthermore the first temperature control structure is formed on a face that is remote from the second housing element.

The second housing element is connected on a face that is remote from the inner chamber, in particular faces that are remote from the first housing element, to a third housing element. In this case, the third housing element receives a second element of the battery control system.

Furthermore, the third housing element forms a second temperature control structure on a face that is turned towards the second housing element. In addition, a second covering element is connected to the third housing element and limits a second temperature control chamber, through which temperature control fluid may flow, in a fluid-tight manner.

In particular, one embodiment in accordance with the invention of the battery offers the advantage that components that convey the temperature control fluid are arranged outside the inner chamber, with the result that in the event of leakages the temperature control fluid may not pass to the battery cells, as a result of which it is possible to increase safety and reliability. In addition, it is possible to cool the individual components in an efficient manner since comparably short thermal paths are produced.

It is advantageous if the first element of the battery control system comprises at least one electrical component of the battery module and/or at least one electronic component of the battery module and if the second element of the battery control system is an electrical voltage convertor, in particular a DC convertor.

It is expedient if the first housing element, the second housing element and/or the third housing element are each embodied as die-cast housings. As a consequence, it is possible to provide a mechanically comparably stable configuration. In addition, it is consequently possible that regions that convey the temperature control fluid may be embodied within the respective die-cast components or are formed by way of connecting a die-cast component and a covering element to one another, with the result that it is possible to forego additional cooling plates, heating elements or temperature control systems.

It is advantageous if the first housing element and the second housing element are connected to one another in a fluid-tight manner. In particular, a first sealing element is arranged between the first housing element and the second housing element.

Consequently, an inner chamber of the battery is provided that is sealed in a fluid-tight manner. In particular, this renders it possible to protect the battery cells, the electrical component and/or the electronic components from external influences.

In accordance with a preferred aspect of the invention, the plurality of battery cells is embodied as prismatic battery cells. Prismatic battery cells comprise hereby a total of six side faces that are arranged in pairs lying opposite one another and parallel to one another. Furthermore, side faces that are arranged adjacent to one another are arranged at right angles with respect to one another. Overall, it is possible to provide a compact battery by way of using prismatically embodied battery cells in a battery in accordance with the invention.

It is preferred if the electrical component of the battery module is a cell connector and/or a cable. Cell connectors are embodied so as to connect voltage tap-offs of battery cells in an electrically conductive manner in series and/or in parallel to one another. Cables are embodied so as to conduct electrical current from one component to another component.

It is preferred if the electronic component of the battery module is a switch, a safety element, a battery control system and/or a resistor.

It is possible by way of arranging the electrical component and/or the electronic component within the inner chamber of the battery to connect the plurality of battery cells of the battery module in an electrically conductive manner in series and/or in parallel to one another and also to open-loop control and closed-loop control the battery module.

In accordance with a preferred aspect of the invention, the at least one electronic component is integrated into a circuit board. This offers the advantage of a comparably compact configuration, the temperature of which is furthermore simple to control.

It is expedient if a first covering element is connected to the first housing element and limits a first temperature control chamber, through which temperature control fluid may flow, in a fluid-tight manner, the covering element being connected to the first housing element in particular in a material-bonded manner, and a second sealing element furthermore being arranged between the first housing element and the covering element.

In this case, the covering element and the first temperature control structure thus in particular jointly form a first temperature control chamber through which temperature control fluid may flow. In this case, it is possible by way of example for the temperature control fluid, which is flowing directly in a thermally conductive manner from one of the first temperature control chambers, to flow around the temperature control structure.

This offers the advantage that the first temperature control structure may be adapted to the requirements with regard to controlling the temperature of the plurality of battery cells that are arranged in the inner chamber. In this case, it is possible to adjust the manner in which the temperature control procedure is adapted independently of the procedure of cooling the electrical component and/or the electronic component and also independently of the procedure of cooling the electrical voltage convertor. By way of example, the first temperature control structure may comprise flow disturbing elements or flow guiding elements that are only arranged at sites where on account of the required temperatures of the plurality of battery cells they may have a positive influence on the temperature control procedure. Furthermore, the remaining regions of the first temperature control chamber may be optimized with respect to the flow and loss of pressure. In particular, it is possible to forego a compromise between controlling the temperature of the plurality of battery cells and of the electrical component and/or the electronic component and also the electrical voltage convertor since it is possible to control the temperature of these components independently of one another.

It is preferred in this case that the covering element is connected to the first housing element in a material-bonded manner. In particular, the covering element may be welded or soldered to the first housing element. Furthermore, a second sealing element may be arranged between the first housing element and the covering element.

It is also preferred for it to be possible if the covering element is formed by the first housing element.

Overall, this offers the advantage that it is possible by way of such a configuration to prevent temperature control fluid from passing into the inner chamber to the plurality of battery cells if defects or leakage sites occur in the first temperature control chamber.

In an advantageous manner, the battery comprises a first connection and a second connection. The first connection is embodied in this case so as to convey the temperature control fluid to the battery and the second connection is embodied in this case so as to discharge the temperature control fluid from the battery.

In particular, the first connection and the second connector form an interface to a motor vehicle.

In accordance with a first aspect, the temperature control fluid may flow through the first temperature control fluid receiving facility and the second temperature control fluid receiving facility in series. In this case, the temperature control fluid flows by way of example initially through the first temperature control fluid receiving facility and subsequently through the second temperature control fluid receiving facility.

In accordance with a second aspect of the invention, the temperature control fluid may flow through the first temperature control fluid receiving facility and the second temperature control fluid receiving facility in parallel. In this case, after it has flowed through the first connection, the temperature control fluid is divided into a first part flow, which flows through the first temperature control fluid receiving facility, and a second part flow which flows through the second temperature control fluid receiving facility. The first part flow and the second part flow are rejoined after they have flowed through the respective temperature control chamber receiving facility and discharged from the battery by means of the second connection. It is possible hereby by way of example to minimize the pressure loss.

In particular, the first housing element and the second housing element and/or the third housing element hereby each comprise a temperature control fluid inlet and a temperature control fluid outlet. The respective temperature control fluid inlet is used so as to allow temperature control fluid into the first flow chamber or the second flow chamber and the respective temperature control fluid outlet is used so as to allow temperature control fluid to flow out from the first flow chamber or the second flow chamber. Furthermore, a temperature control fluid inlet and a temperature control fluid outlet may be connected to one another in a fluid-conducting manner with the result that temperature control fluids may flow between the first flow chamber and the second flow chamber or conversely.

By way of example, the temperature control fluid inlet of the second housing element and/or of the third housing element form the first connection of the battery with the result that temperature control fluid may flow into the second flow chamber. Furthermore, by way of example, the temperature control fluid outlet of the second housing element and/or of the third housing element may be connected to the temperature control fluid inlet of the first housing element in a fluid-conducting manner with the result that temperature control fluid may first flow through the second flow chamber and subsequently through the first flow chamber, in other words a series through-flow connection is formed. In addition, by way of example, the temperature control fluid outlet of the first housing element may form the second connection of the battery with the result that hereby temperature control fluid may exit the first flow chamber.

By way of example, the temperature control fluid inlet of the first housing element may form the first connection of the battery with the result that hereby temperature control fluid may flow into the first flow chamber. Furthermore, by way of example, the temperature control fluid outlet of the first housing element may be connected in a fluid-conducting manner to the temperature control fluid inlet of the second housing element and/or of the third housing element with the result that temperature control fluid may first flow through the first flow chamber and subsequently through the second flow chamber, in other words a series through-flow connection is formed. In addition, by way of example, the temperature control fluid outlet of the second housing element and/or of the third housing element may form the second connection of the battery with the result that hereby temperature control fluid may exit the second flow chamber.

It is preferred that the first temperature control structure, the second temperature control structure and/or the third temperature control structure are each embodied as flow guiding elements, as flow disturbing elements or as flow limiting elements.

In particular, the first temperature control structure, the second temperature control structure and/or the third temperature control structure may each be formed by the corresponding die-cast housing.

At this point, flow guiding elements are to be understood to be such elements that are arranged within a respective temperature control chamber and that are used to deflect a flow without creating a comparable increase in turbulence.

At this point, flow disturbing elements are to be understood to be such elements that are arranged within a respective temperature control chamber and that are used to increase the turbulence of a flow, in particular to create a transition from a laminar flow to a turbulent flow in order however to improve the manner in which heat is discharged.

At this point, flow limiting elements are to be understood to be such elements that mechanically limit the respective temperature control chamber.

In particular, it is to be noted that for this purpose the second temperature control structure and the third temperature control structure jointly may influence a temperature control fluid that is flowing through the second flow chamber.

It is of advantage if the plurality of battery cells is connected in a fluid-conducting manner to a first inner face of the inner chamber, wherein the first inner face is arranged directly adjacent to the first temperature control structure. In particular, in so doing a first thermal compensating element, such as by way of example a thermally conductive adhesive material, may be arranged between the plurality of battery cells and the inner face.

It is also advantageous if the first element of the battery control system is connected to a second inner face of the inner chamber in a thermally conductive manner, wherein the second inner face is arranged directly adjacent to the third housing element. In particular, in so doing, for example a second thermal compensating element, such as by way of example a thermally conductive adhesive material or a so-called thermal interface material (TIM), may be arranged between the electrical component and/or the electronic component.

By way of example, it is possible by way of connecting a circuit board that comprises the electronic component to the second housing element, by way of example by means of screws, to form a reliable thermal conductive path. Overall, a comparably short thermal path is hereby created between a temperature control fluid, which is flowing through the second temperature control chamber, and the circuit board having a consequently comparably low thermal resistance.

Furthermore, it is advantageous if the second element of the battery control system is connected in a thermally conductive manner to an inner face of the third housing element, wherein this inner face is arranged directly adjacent to the second housing element. In so doing, for example, furthermore a third thermal compensating material, such as by way of example a thermally conductive adhesive material or a so-called thermal interface material (TIM), may be arranged between the electrical voltage convertor and the inner face of the third housing element. It is possible by way of connecting, such as by way of example by means of screws, the electrical voltage convertor to the third housing element to form a reliable thermal conductive path. Overall, a comparably short thermal path is hereby created between a temperature control fluid, which is flowing through the second temperature control chamber, and the electrical voltage convertor having a consequently comparably low thermal resistance.

Subject matter of the present invention is also the use of an above-described battery in accordance with the invention so as to control the temperature and in particular to cool the plurality of battery cells, the first element of the battery control system and the second element of the battery control system, in particular the electrical component and/or the electronic component and/or the electrical voltage convertor, wherein a temperature control fluid, which is in the form of a temperature control liquid or a temperature control gas, flows around the first temperature control structure or wherein the temperature control fluid that is in the form of a temperature control liquid flows around the second temperature control structure.

### BRIEF DESCRIPTION OF THE DRAWINGS

Exemplary embodiments of the invention are illustrated in the drawings and further explained in the description below.

In the drawings:

FIG. 1a illustrates in a perspective view a battery that is a first embodiment of the invention,

FIG. 1b illustrates in a perspective view a battery that is a second embodiment of the invention,

FIG. 2a illustrates in a lateral view the battery of the first embodiment,

FIG. 2b illustrates in a lateral view the battery of the second embodiment,

FIG. 3a illustrates a bottom view of a third housing element of the first embodiment,

FIG. 3b illustrates a bottom view of a third housing element of the second embodiment,

FIG. 4a illustrates a plan view of the third housing element of the first embodiment,

FIG. 4b illustrates a plan view of the third housing element of the second embodiment,

FIG. 5a illustrates an arrangement of a covering element of the first embodiment,

FIG. 5b illustrates an arrangement of a covering element of the second embodiment,

FIG. 5c illustrates a top face of the covering element of the second embodiment,

FIG. 6a illustrates in a perspective view an exploded illustration of a section of the first embodiment, and

FIG. 6b illustrates in a perspective view an exploded illustration of a section of the second embodiment.

### DETAILED DESCRIPTION

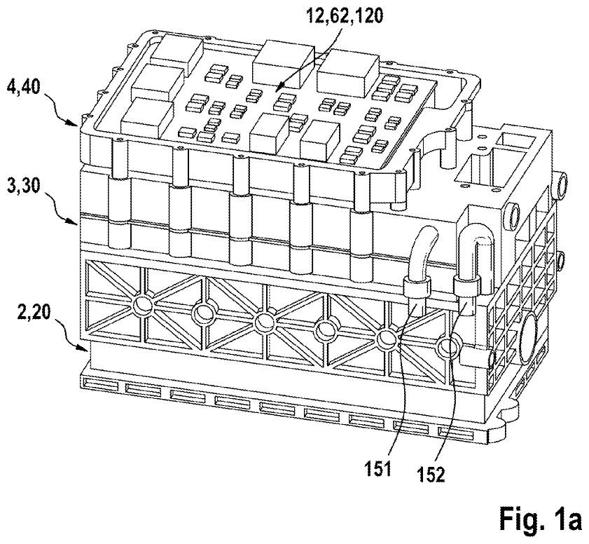

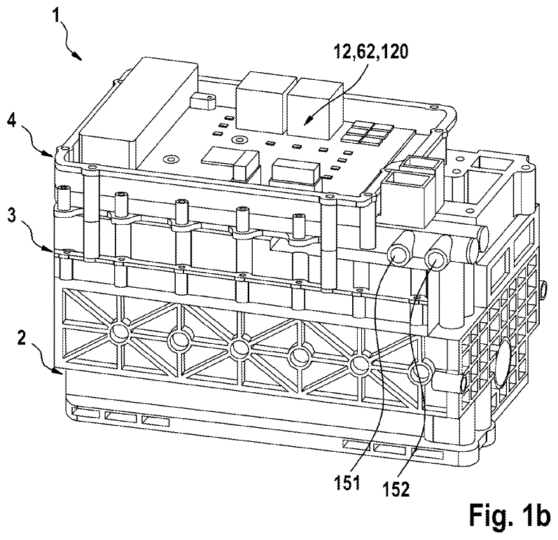

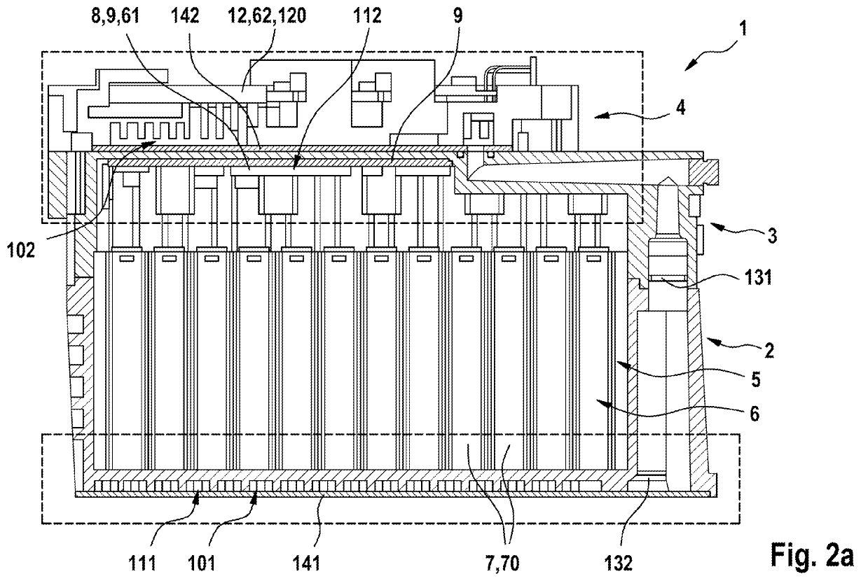

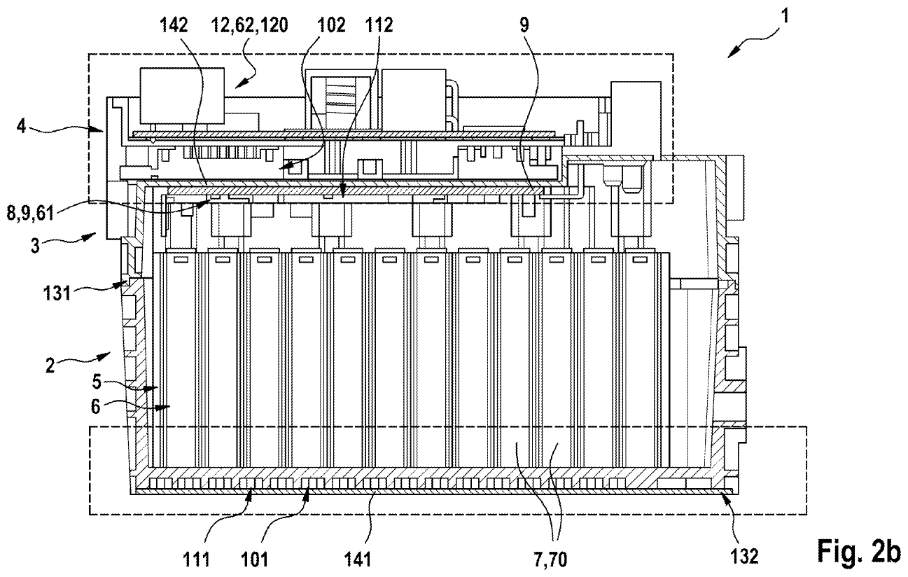

FIG. 1a illustrates in a perspective view a battery 1 that is a first embodiment of the invention. FIG. 2a illustrates the battery 1 of the first embodiment in a lateral view.

FIG. 1b illustrates in a perspective view a battery 1 that is a second embodiment of the invention. FIG. 2b illustrates the battery 1 of the second embodiment a lateral view.

A substantially joint description of FIGS. 1a, 1b, 2a and 2b is now provided.

In this case, the battery 1 comprises a first housing element 2, a second housing element 3 and a third housing element 4. According to the first embodiment and second embodiment of the battery 1 illustrated in FIGS. 1a, 1b, 2a and 2b, the first housing element 2 is embodied as a die-cast housing 20, the second housing element 3 is embodied as a die-cast housing 30 and the third housing element 4 is embodied as a die-cast housing 40.

The first housing element 2 and the second housing element 3 jointly form an inner chamber 5 for receiving a battery module 6. In particular, the inner chamber 5 and the battery module 6 are apparent in the sectional view according to FIG. 2a or 2b. In particular, the first housing element 2 and the second housing element 3 are connected to one another in a fluid-tight manner. In this case, a first sealing element 131 is furthermore for example arranged between the first housing element 2 and the second housing element 3. In particular, the first housing element 2 and the second housing element 3 may be connected to one another for example in screwed form.

A plurality of battery cells 7 is arranged in the inner chamber 5. The plurality of battery cells 7 of the battery module 6 is in this case connected in an electrically conductive manner in series and/or in parallel to one another. It is preferred, as is apparent in particular in FIG. 2, to embody the plurality of battery cells 7 as prismatic battery cells 70.

Furthermore, a first element 61 of a battery control system is arranged in the inner chamber 5. In this case, in particular, electrical components 8 of the battery module 6 and electronic components 9 of the battery module 6 are arranged in the inner chamber 5. By way of example, the electrical components 8 may be cell connectors that connect the plurality of battery cells 7, 70 in an electrically conductive manner in series and/or parallel to one another. Furthermore, the electrical components 8 are cables that conduct electrical current. By way of example, the electronic components 9 of the battery module 6 may be switches, safety elements, battery control systems and/or resistors. In particular, it is preferred that the electronic components 9, as is apparent in FIG. 2a, 2b, are integrated at least in part into a circuit board 90.

The first housing element 2 forms a first temperature control structure 101 on a face that is remote from the inner chamber 5. In particular in the case of the embodiment according to FIGS. 1a, 1b, 2a and 2b, the first temperature control 101 is arranged on a face of the first housing element 2 that is remote from the second housing element 3. Furthermore, FIG. 2a or 2b also illustrates that a first covering element 141 is arranged on the first housing element 2. In this case, the first covering element 141 and the first housing element 2 jointly form a first temperature control chamber 111 through which temperature control fluid may flow. The first temperature control structure 101 is in this case arranged within the first temperature control chamber 111. In particular, the first covering element 141 may be connected in a material-bonded manner to the first housing element 2. In this case, it is furthermore preferred that a second sealing element 132 is arranged between the first housing element 2 and the first covering element 141.

The second housing element 3 is connected to the third housing element 4 on a face that is remote from the inner chamber 5. In particular, the second housing element 3 is connected to the third housing element 4 on a face that is remote from the first housing element 2.

The third housing element 4 receives in this case a second element 62 of the battery control system. The second element 62 of the battery control system is preferably an electrical voltage convertor 12. In particular, the electrical voltage convertor 12 is a DC convertor 120.

The third housing element 4 forms a second temperature control structure 102 on a face that is turned towards the second housing element 2. In addition, a second covering element 142 is connected to the third housing element 4 and limits a second temperature control chamber 112, through which temperature control fluid may flow, in a fluid-tight manner.

Furthermore, FIG. 1a or 1b illustrates in particular that the battery 1 comprises a first connection 151 and a second connection 152. The first connection 151 is embodied in this case so as to guide temperature control fluid to the battery 1 and the second connection 152 is embodied in this case so as to discharge temperature control fluid from the battery 1. In this case, the temperature control fluid may flow through the battery 1 and in particular the first temperature control chamber 111 and the second temperature control chamber 112 in series or in parallel.

Overall, it is apparent from FIG. 2a or 2b that the first temperature control chamber 111 and the second temperature control chamber 112 are arranged separately. In particular, the first temperature control chamber 111 is arranged in the lower region of the battery 1 on the first housing element 2 and the second temperature control chamber 112 is arranged in the upper region of the battery 1 between the second housing element 3 and the third housing element 4.

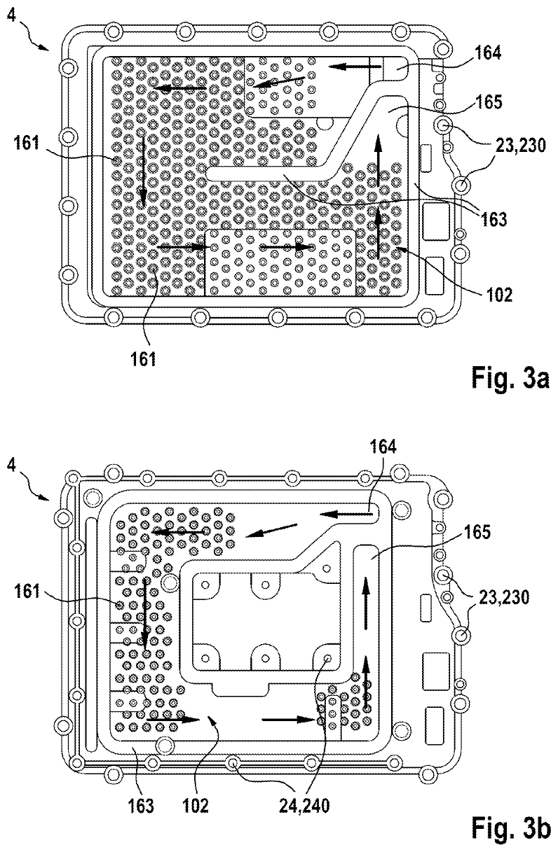

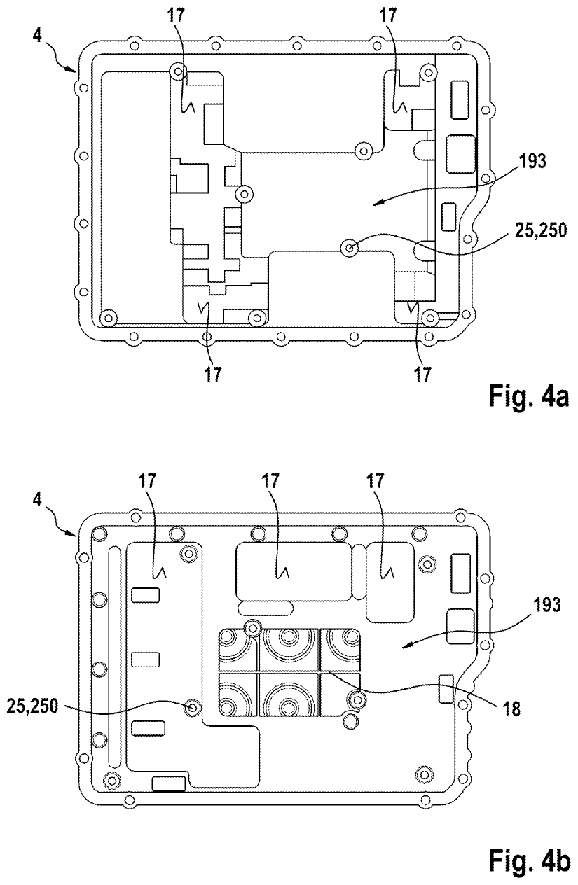

FIG. 3a illustrates in a perspective view a bottom view of the third housing element 4 of the first embodiment. Furthermore, FIG. 4a illustrates in a perspective view a plan view of the the third housing element 4 according to FIG. 3a.

FIG. 3b illustrates in a perspective view a bottom view of the third housing element 4 of the second embodiment. Furthermore, FIG. 4b illustrates in a perspective view a plan view of the third housing element 4 according to FIG. 4a.

The third housing element 4 is now described with reference to FIGS. 3a, 3b, 4a and 4b jointly.

It is initially apparent that the third housing element 4 forms the second temperature control structure 102. The second temperature control structure 102 is formed on a face that is turned towards the second housing element 3 when the third housing 4 is arranged in the battery 1.

By way of example the second temperature control structure 102 may comprise flow guiding elements 161, flow disturbing elements 162 and flow limiting elements 163. Furthermore, the third housing element 4 may comprise in each case a temperature control fluid inlet 164 and a temperature control fluid outlet 165. In particular, the flow may be consequently guided as indicated by the arrows within the second temperature control chamber 112.

Furthermore, possible connecting elements 23 that are embodied as screw-connection points 230, configured so as to connect to the second housing element 3, are also apparent in FIGS. 3a and 3b.

In addition, possible connecting elements 24 that are embodied as screw-connection points 240, configured so as to connect to the second covering element 142, are also apparent in particular in FIG. 3b.

In addition, FIG. 4a or 4b furthermore illustrates an inner face 193 of the third housing element 4. The inner face 193 of the third housing element 4 is arranged in this case directly adjacent to the second housing element 3 when the third housing element 4 is arranged in the battery 1. The second element 62 of the battery control system may be connected in this case in a thermally conductive manner to the inner face 193.

Thermal contact areas 17 are also apparent in this case, which are in particular configured for thermally conductive connection of the second element 62 of the battery control system. In addition, possible connecting elements 25 that are embodied as screw-connection points 250, configured so as to connect to the second element 62 of the battery control system, are also apparent.

Additionally, thermal conductor elements 18, which can increase thermal conductivity, are also apparent, in particular in FIG. 4b.

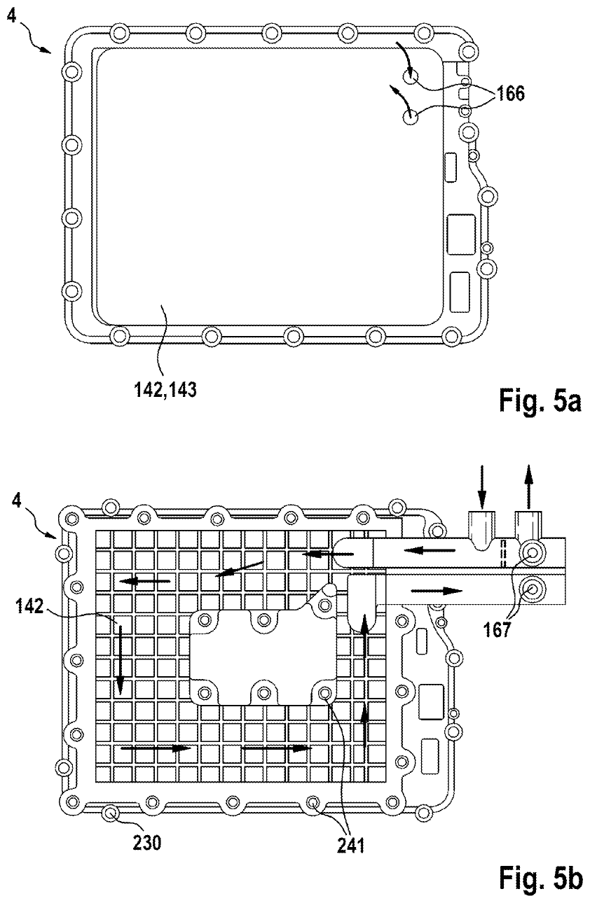

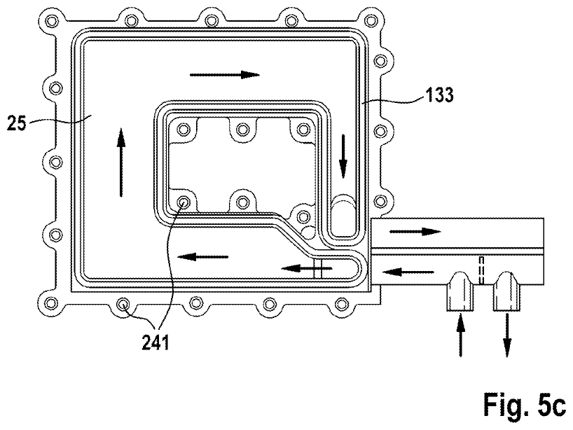

FIG. 5a shows an arrangement of the second covering element 142 of the first embodiment and FIG. 5b shows an arrangement of the second covering element 142 of the second embodiment.

The underside of the third housing element 4 is apparent in each case, a second covering element 142 being connected to the third housing element 4. This limits the second temperature control chamber 112, through which temperature control fluid may flow, in a fluid-tight manner.

In particular, the second covering element 142 according to FIG. 5a comprises passages 166 for the temperature control fluid inlet 165 and the temperature control fluid outlet 166 in this case. These passages 166 can be used for connection to the second housing element 3 in a fluid-conducting manner. According to FIG. 5a, the covering element 142 is embodied as a planar component 143 made from a metallic material. This allows the second housing element 3 to be connected to the covering element 142 in a planar manner.

Furthermore, the covering element 142 according to FIG. 5b comprises connections 167 in this case that can be connected to the second housing element 3 in a fluid-conducting manner. Moreover, passages 241 for the associated screw-connection points 240 are again apparent and, by way of example, the screw-connection points 230 are also apparent.

FIG. 5c shows a top face of the second covering element 142 of the second embodiment according to FIG. 5b.

In particular, the passages 241 are initially apparent in this case.

In addition, a third sealing element 133 is apparent, which is used for sealing the second temperature control chamber 112 formed in a fluid-tight manner.

In addition, the flow guidance formed in the second temperature control chamber 112 is also shown.

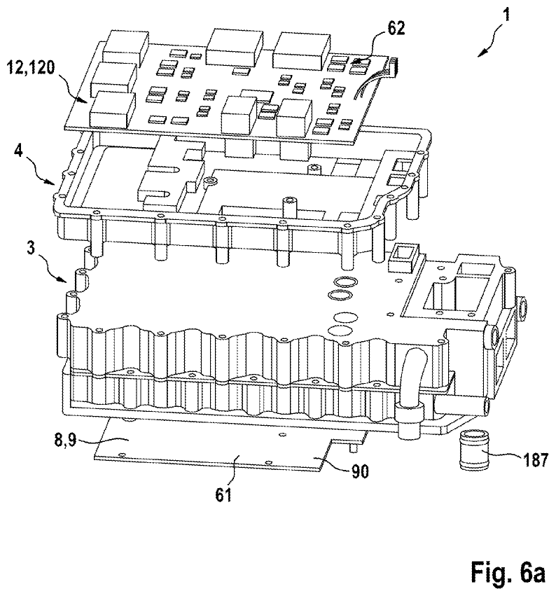

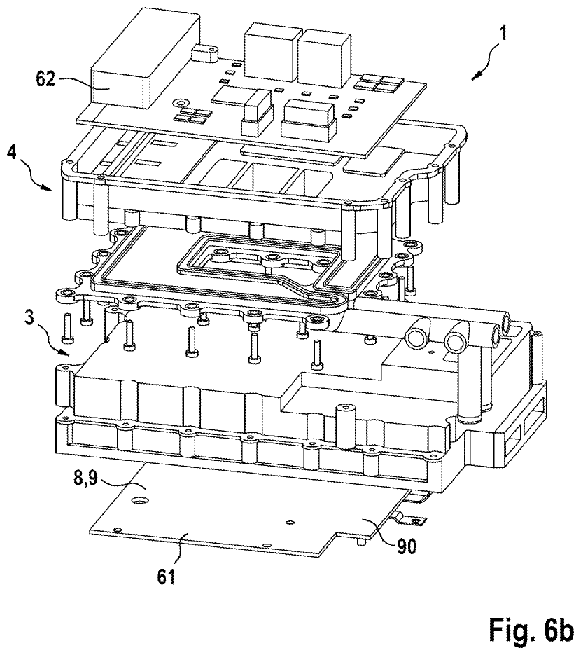

FIG. 6a illustrates in a perspective view an exploded illustration of a section of the first embodiment.

FIG. 6b illustrates in a perspective view an exploded illustration of a section of the second embodiment.

In this case, the second housing element 3 and the third housing element 4 are apparent. In addition, the first element 61 of the battery control system is also illustrated, which may comprise the electrical components 8 or the electronic components 9 which is integrated by way of example into a circuit board 90. Moreover, the second element 62 of the battery control system, in particular the electrical voltage convertor 12 that is embodied by way of example as a DC convertor 120, is also apparent.

The third housing element 4 is connected to the second housing element 3 in this case. By way of example, this connection can be made in screwed form. At this juncture, it will be noted that in this case the second covering element 142 limits a respective second temperature control chamber 112 in a fluid-tight manner, said temperature control chamber therefore being arranged in particular between the second housing element 3 and the third housing element 4.

In addition, FIG. 6a or 6b also illustrates a connecting piece 187 that is used so as to connect corresponding temperature control fluid inlets and corresponding temperature control fluid outlets with the result that a series through-flow arrangement of the first temperature control chamber 111 and the second temperature control chamber 112 is formed.

1. A battery comprising a first housing element (2) and a second housing element (3), which jointly form an inner chamber (5) for receiving a battery module (6),
wherein a plurality of battery cells (7) of the battery module (6) is arranged in the inner chamber (5), said battery cells being connected in an electrically conductive manner in series and/or in parallel to one another,
wherein a first element (61) of a battery control system is arranged in the inner chamber (5), and the first housing element (2) forms a first temperature control structure (101) on a first face that is remote from the inner chamber (5), and the second housing element (2) is furthermore connected to a third housing element (4) on a second face that is remote from the inner chamber (5),
wherein the third housing element (4) receives a second element (62) of the battery control system, and
wherein the third housing element (4) forms a second temperature control structure (102) on a face that is turned towards the second housing element (2), and, furthermore, a second covering element (142) is connected to the third housing element (4) and limits a second temperature control chamber (112), through which temperature control fluid may flow, in a fluid-tight manner.

2. The battery according to claim 1, wherein the first element (61) of the battery control system comprises at least one electrical component (8) and/or at least one electronic component (9) of the battery module (6) and that the second element (62) of the battery control system is an electrical voltage convertor (12).

3. The battery according to claim 1, wherein the first housing element (2), the second housing element (3) and/or the third housing element (4) are each embodied as die-cast housings (20, 30, 40).

4. The battery according to claim 1, wherein the first housing element (2) and the second housing element (3) are connected in a fluid-tight manner to one another.

5. The battery according to claim 1, wherein the plurality of battery cells (7) is embodied as prismatic battery cells (70).

6. The battery according to claim 2, wherein the electrical component (8) of the battery module (6) is a cell connector and/or a cable and/or that the electronic component (9) of the battery module (6) is a switch, a safety element, a battery control system and/or a resistor.

7. The battery according to claim 1, wherein the first element (61) of the battery control system is integrated into a circuit board (9).

8. The battery according to claim 1, wherein a first covering element (141) is connected to the first housing element (2) and limits a first temperature control chamber (111), through which temperature control fluid may flow, in a fluid-tight manner, wherein the first covering element (141) is connected to the first housing element (2), and furthermore a second sealing element (132) is arranged between the first housing element (2) and the first covering element (141).

9. The battery according to the preceding claim 8, wherein the battery (1) has a first connection (151) that is configured to convey temperature control fluid to the battery (1) and a second connection (152) that is configured to discharge temperature control fluid from the battery (1), wherein the battery (1) has temperature control fluid ducts that are configured such that temperature control fluid may flow through the first temperature control chamber (111) and the second temperature control chamber (112) in series or in parallel.

10. The battery according to claim 1, wherein the first temperature control structure (101) and/or the second temperature control structure (102) are each embodied as flow guiding elements (161), as flow disturbing elements (162) and/or as flow limiting elements (163).

11. The battery according to claim 1, wherein the plurality of battery cells (7) is connected in a thermally conductive manner to a first inner face (191) of the inner chamber (5), said first inner face being arranged directly adjacent to the first temperature control structure (101), and wherein the first element (61) of the battery control system is arranged in a thermally conductive manner to a second inner face (192) of the inner chamber (5), said second inner face being arranged directly adjacent to the third housing element (4) and/or the second element (62) of the battery control system is arranged in a thermally conductive manner to an inner face (193) of the third housing element (4), said inner face of the third housing element being arranged directly adjacent to the second housing element (3).

12. A method comprising the steps of:
providing a battery (1) according to claim 1; and
controlling the temperature and cooling the plurality of battery cells (7), the first element (61) and/or the second element (62), wherein a temperature control fluid, which is in the form of a temperature control liquid or a temperature control gas, flows around the first temperature control structure (101) or wherein the temperature control fluid that is in the form of a temperature control liquid flows around the second temperature control structure (102).

13. The battery according to claim 1, wherein the first face is remote from the second housing element (3), and the second face is remote from the first housing element (3).

14. The battery according to claim 13, wherein the first element (61) of the battery control system comprises at least one electrical component (8) and/or at least one electronic component (9) of the battery module (6) and the second element (62) of the battery control system is a DC convertor (120).

15. The battery according to claim 14, wherein the first housing element (2), the second housing element (3) and/or the third housing element (4) are each embodied as die-cast housings (20, 30, 40).

16. The battery according to claim 15, wherein the first housing element (2) and the second housing element (3) are connected in a fluid-tight manner to one another, wherein a first sealing element (131) is arranged between the first housing element (2) and the second housing element (3).

17. The battery according to claim 16, wherein the plurality of battery cells (7) is embodied as prismatic battery cells (70).

18. The battery according to claim 14, wherein the electrical component (8) of the battery module (6) is a cell connector and/or a cable and/or that the electronic component (9) of the battery module (6) is a switch, a safety element, a battery control system and/or a resistor.

19. The battery according to claim 18, wherein the first element (61) of the battery control system is integrated into a circuit board (9).

20. The battery according to claim 19, wherein a first covering element (141) is connected to the first housing element (2) and limits a first temperature control chamber (111), through which temperature control fluid may flow, in a fluid-tight manner, wherein the first covering element (141) is connected to the first housing element (2) in a material-bonded manner, and furthermore a second sealing element (132) is arranged between the first housing element (2) and the first covering element (141).
